(19) United States
(12) Patent Application Publication
(10) Pub. No.: US 2020/0111066 A1
(43) Pub. Date: Apr. 9, 2020

(54) SYSTEM, DEVICES AND METHOD FOR APPROXIMATING A GEOGRAPHIC ORIGIN OF A CRYPTOCURRENCY TRANSACTION

(71) Applicant: Blockchain Technology Group Inc. DBA Blockchain Intelligence Group, Vancouver (CA)

(72) Inventors: Marty Robert Anstey, Salmon Arm (CA); Wojciech Szmigielski, Surrey (CA); Shone Anstey, Richmond (CA)

(73) Assignee: Blockchain Technology Group Inc. DBA Blockchain Intelligence Group, Vancouver (CA)

(21) Appl. No.: 16/610,052

(22) PCT Filed: Apr. 30, 2018
(86) PCT No.: PCT/CA2018/050504

§ 371 Date: Oct. 31, 2019

Related U.S. Application Data
(60) Provisional application No. 62/492,621, filed on May 1, 2017.

(51) Int. Cl. G06Q 20/06; H04L 9/32; H04L 9/06; H04L 12/58; H04L 29/08

(52) U.S. Cl. CPC G06Q 20/0655; H04L 9/3297; H04L 9/0637; H04L 2209/56; H04L 67/104; G06Q 2220/00; H04L 2209/38; H04L 51/20

(57) ABSTRACT

In one aspect, a server for approximating a geographic origin of a cryptocurrency transaction in a peer-to-peer (P2P) mesh network of cryptocurrency nodes employing a gossip protocol comprises: a network interface controller for communicating with a plurality of geographically distributed cryptocurrency nodes forming part of the P2P mesh network; and a processor, in communication with the network interface controller, operable to: receive, from each of the geographically distributed cryptocurrency nodes: a timestamp representing a time at which an earliest indication of the transaction was received at the cryptocurrency node; and a unique identifier of a peer of the cryptocurrency node, forming part of the P2P mesh network, from which the earliest indication of the transaction was received; based on the timestamps received from the geographically distributed cryptocurrency nodes, identify one of the peers as a most likely originator of the transaction; and map the unique identifier to a geographic area.

### CROSS-REFERENCE TO RELATED APPLICATIONS

The present application claims the benefit of prior U.S. provisional application Ser. No. 62/492,621 filed May 1, 2017, the contents of which are hereby incorporated by reference.

### TECHNICAL FIELD

The present application pertains to cryptocurrency systems, and more specifically to a system, devices and method for approximating a geographic origin of a cryptocurrency transaction.

### BACKGROUND

A cryptocurrency is a digital medium of exchange that uses computers and encryption for generating units of currency and conducting transactions using the currency without requiring oversight by a central authority, such as a bank. Bitcoin is one example of a cryptocurrency.

A cryptocurrency user may have an associated pseudonym. For example, a Bitcoin address generated from a public encryption key may be considered as a pseudonym of a Bitcoin user. Users may conduct cryptocurrency transactions using only their pseudonyms. As a result, users may lack even basic information about those with whom they conduct cryptocurrency transactions, such as their names and addresses. For that reason, cryptocurrencies may be attractive to people wishing to discreetly make transactions of an illicit nature—e.g. for purposes such as money laundering, evading financial sanctions, or supporting terrorism—without revealing their geographic location.

### SUMMARY

In one aspect, there is provided a server for approximating a geographic origin of a cryptocurrency transaction in a peer-to-peer (P2P) mesh network of cryptocurrency nodes employing a gossip protocol, the server comprising: a network interface controller for communicating with a plurality of geographically distributed cryptocurrency nodes forming part of the P2P mesh network of cryptocurrency nodes; and a processor, in communication with the network interface controller, operable to: receive, from each cryptocurrency node of the plurality of geographically distributed cryptocurrency nodes: a timestamp representing a time at which an earliest indication of the cryptocurrency transaction was received at the cryptocurrency node; and a unique identifier of a peer of the cryptocurrency node, the peer forming part of the P2P mesh network of cryptocurrency nodes, from which the earliest indication of the cryptocurrency transaction was received; based on the plurality of timestamps received from the respective plurality of geographically distributed cryptocurrency nodes, identify one of the peers as a most likely originator of the cryptocurrency transaction; and map the unique identifier of the most likely originator peer to a geographic area.

In another aspect, there is provided a cryptocurrency node for facilitating approximation of a geographic origin of a cryptocurrency transaction in a peer-to-peer (P2P) mesh network of cryptocurrency nodes, the cryptocurrency node comprising: a system clock; and a processor operable to cause the cryptocurrency node to: receive, from at least one peer of the cryptocurrency node within the P2P mesh network of cryptocurrency nodes, at least one indication of the cryptocurrency transaction conveyed using a gossip protocol; record a time, using the system clock, at which the first indication of the cryptocurrency transaction was received at the cryptocurrency node; and record a unique identifier of the peer from which the first indication of the cryptocurrency transaction was received at the cryptocurrency node.

In a further aspect, there is provided a system for approximating a geographic origin of a cryptocurrency transaction in a peer-to-peer (P2P) mesh network of cryptocurrency nodes, the system comprising: a plurality of geographically distributed cryptocurrency nodes forming part of the P2P mesh network, each of the cryptocurrency nodes of the plurality operable to: receive, from at least one peer of the cryptocurrency node within the P2P mesh network, at least one indication of the cryptocurrency transaction conveyed using a gossip protocol; record a time at which the first indication of the cryptocurrency transaction was received at the cryptocurrency node; and record a unique identifier of the peer from which the first indication of the cryptocurrency transaction was received at the cryptocurrency node; and a server, in communication with each of the geographically distributed cryptocurrency nodes, operable to: receive, from each cryptocurrency node of the plurality of geographically distributed cryptocurrency nodes: a timestamp representing the recorded time at which the earliest indication of the cryptocurrency transaction was received at the cryptocurrency node; and a unique identifier of the peer of the cryptocurrency node from which the earliest indication of the cryptocurrency transaction was received; based on the plurality of timestamps received from the respective plurality of geographically distributed cryptocurrency nodes, identify one of the peers as a most likely originator of the cryptocurrency transaction; and map the unique identifier of the most likely originator peer to a geographic area.

In yet another aspect, there is provided a method for approximating a geographic origin of a cryptocurrency transaction in a peer-to-peer (P2P) mesh network of cryptocurrency nodes, the method comprising: at each cryptocurrency node of a plurality of geographically distributed cryptocurrency nodes forming part of the P2P mesh network: receiving, from at least one peer of the cryptocurrency node within the P2P mesh network, at least one indication of the cryptocurrency transaction conveyed using a gossip protocol; recording a time at which the first indication of the cryptocurrency transaction was received at the cryptocurrency node; and recording a unique identifier of the peer from which the first indication of the cryptocurrency transaction was received at the cryptocurrency node; and receiving, from each cryptocurrency node of the plurality of geographically distributed cryptocurrency nodes: a timestamp representing the recorded time at which the earliest indication of the cryptocurrency transaction was received at the cryptocurrency node; and a unique identifier of the peer of the cryptocurrency node from which the earliest indication of the cryptocurrency transaction was received; based on the plurality of timestamps received from the respective plurality of geographically distributed cryptocurrency nodes, identifying one of the peers as a most likely originator of the cryptocurrency transaction; and mapping the unique identifier of the most likely originator peer to a geographic area.

### BRIEF DESCRIPTION OF THE DRAWINGS

In the figures which illustrate example embodiments:

FIG. 1 is a schematic diagram depicting an example cryptocurrency network in which a geographically distributed set of listener nodes is to be established;

FIG. 1A schematically depicts a single example listener node to be added to the cryptocurrency network of FIG. 1;

FIG. 2 is a flowchart of operation of a listener node for connecting to a cryptocurrency network such as the one depicted in FIG. 1;

FIGS. 3, 4, 5, 6, and 7 schematically depict stages of operation of establishing a geographically distributed set of listener nodes within the cryptocurrency network of FIG. 1;

FIG. 8 is a schematic depiction of a system resulting from the stages of operation shown in FIGS. 3 to 7;

FIG. 9 schematically depicts a server that may be considered as a root node of the system of FIG. 8;

FIG. 10 is a schematic diagram depicting use of the listener nodes of the system of FIG. 8 to approximate the geographic origin of a cryptocurrency transaction;

FIG. 11 is a flowchart of operation of an example listener node for monitoring the propagation of cryptocurrency transactions;

FIG. 12 is a flowchart of operation of the server of FIG. 9 for approximating the geographic origin of a cryptocurrency transaction; and

FIG. 13 is a schematic depiction of an alternative embodiment of the system of FIG. 8.

### DETAILED DESCRIPTION

In overview, a system for approximating a geographic origin of a cryptocurrency transaction (e.g. a Bitcoin transaction) within peer-to-peer (P2P) mesh network of cryptocurrency nodes (e.g. the Bitcoin network) includes a geographically distributed plurality of customized “listener” cryptocurrency nodes and a server in communication with each of the geographically distributed listener nodes. The system may for example be administered by an entity such as a governmental body, a law enforcement agency, or third party working on behalf of such entities (the administrating entity being referred to herein as the “administrator”).

Each listener node establishes P2P connections, via the cryptocurrency network (e.g. Bitcoin network), with non-listener cryptocurrency nodes in the same geographic area as the listener node. In one aspect, the listener node acts as a conventional cryptocurrency node, e.g. relaying cryptocurrency transactions to its peers according to the gossip protocol. In another aspect, the listener node is customized to monitor the propagation of cryptocurrency transactions through the cryptocurrency network in real time. More specifically, each listener node records the time at which it first receives each new cryptocurrency transaction along with the identity (e.g. the IP address) of the peer from which the new transaction was first received (the “sending peer”).

The server, which may be referred to as a “central server” because it communicates with each of the geographically distributed listener nodes, compiles timing and peer information for recent cryptocurrency transactions received from the listener nodes. The compiled information may then be processed to identify, for a recent cryptocurrency transaction, the likely source (i.e. the probable originating cryptocurrency node) of the recent cryptocurrency transaction.

Upon demand, the central server may approximate the geographic origin of the cryptocurrency transaction by mapping the unique identity (e.g. IP address) of the probable originating cryptocurrency node to a likely geographic location of that node. This may for example be done in response to a query, e.g. from a software process or a user, for detailed information about a specific cryptocurrency transaction, possibly as part of an investigation.

The approximate geographic location of an originating cryptocurrency node may be used, optionally in combination with other factors, to flag the associated cryptocurrency transaction as possibly being fraudulent. This may for example be done when the geographic location is known to be in a high-crime area. In the case of Bitcoin, future Bitcoin transactions originating from the same Bitcoin address, or another Bitcoin address associated with the same Bitcoin wallet as that Bitcoin address, may also be automatically flagged as possibly fraudulent. An intended recipient of cryptocurrency could possibly use this information in the future reject a proposed transaction on the basis that it is likely to be fraudulent.

As an analogy, if each cryptocurrency transaction can be likened to a pebble being thrown into a pond, and if the flooding of the cryptocurrency network with indications of that transaction via the gossip protocol can be likened to the spreading of ripples on the surface of the pond, then the listener nodes may be likened to buoys at various points on the surface of the pond that record the earliest arrival time and trajectory of a ripple. Moreover, the server may be considered as a central authority that gathers and processes the information from all the buoys for later use in approximating the point of impact on the surface of the pond of any thrown pebble.

In the description that follows, two aspects of system operation of an example system are described in more detail. The first aspect is the establishment of a geographically distributed plurality of listener nodes as part of a P2P mesh network of cryptocurrency nodes. The second aspect is the use of the geographically distributed listener nodes to listen for new cryptocurrency transactions and the periodic reporting of information, to the central server, regarding new cryptocurrency transactions. For clarity, the description presumes the use of Bitcoin as an example cryptocurrency. However, it will be appreciated that other cryptocurrencies could be used in alternative embodiments.

(a) Establishing a Geographically Distributed Plurality of Listener Nodes within a P2P Mesh Network of Cryptocurrency Nodes

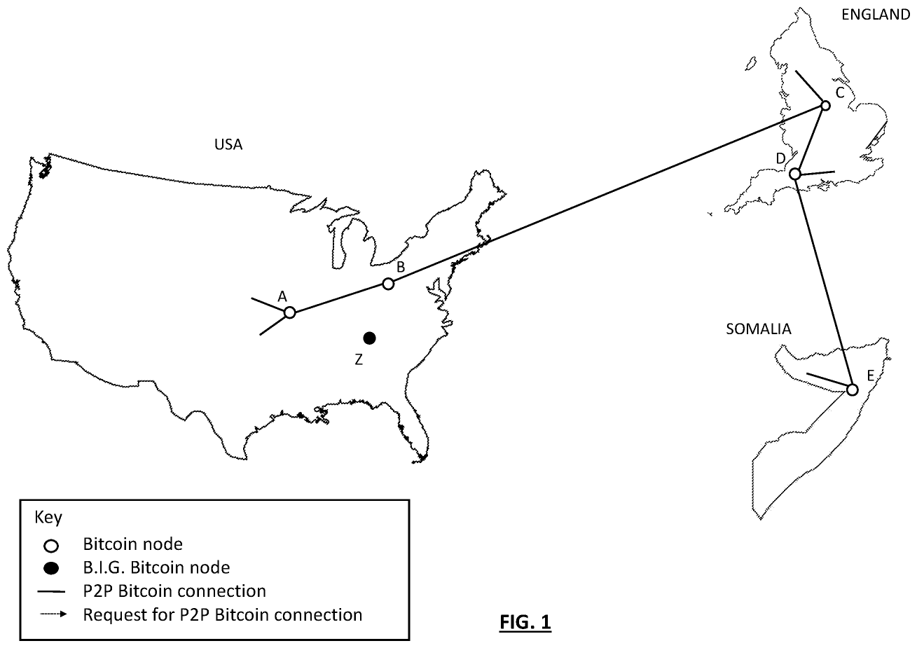

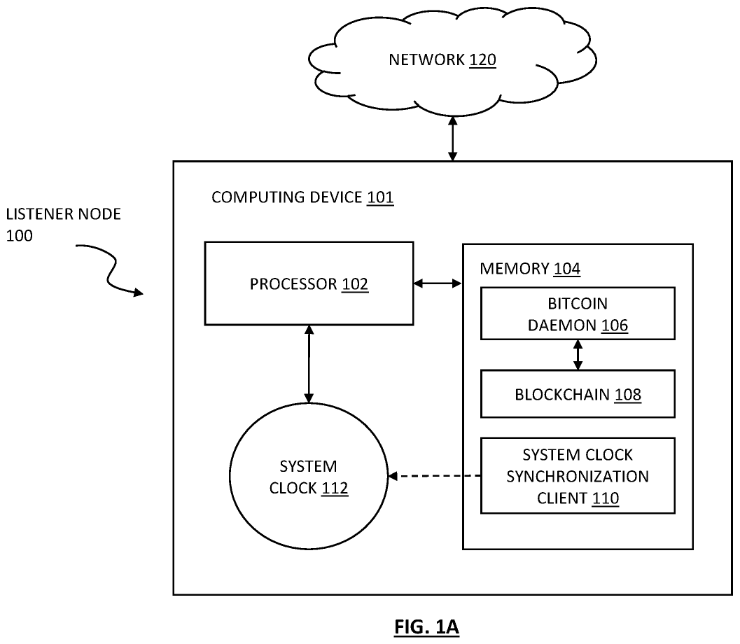

FIG. 1 is a simplified schematic diagram of a portion of the Bitcoin network. Five conventional cryptocurrency (Bitcoin) nodes A, B, C, D and E are illustrated, each represented by an unfilled circle. The term “conventional cryptocurrency node” as used herein, in the case of Bitcoin, refers to an internet-connected computing device (e.g. server, laptop computer, tablet computer, or smartphone) executing Bitcoin daemon software providing, at least, baseline Bitcoin node functionality according to the Bitcoin P2P protocol. The baseline Bitcoin node functionality normally includes the ability to validate and propagate (relay) transactions and blocks and discover and maintain connections to peers. The software may for example be an executable version of the Bitcoin Core source code. The software can be any software that abides by the rules set out in the Bitcoin protocol, such as bitcoin Core (e.g. versions 0.X.Y, where X and Y are integers), bitcoin Unlimited (e.g. versions 1.0.1.0, 1.0.1.1, 1.0.1.2, or 1.0.1.3), and others. It also includes even more customized versions of the Bitcoin protocol set of rules. Bitcoin Core (and possibly other versions of Bitcoin software) is available, at the time of this writing, on the source code hosting website github.com and on the website bitcoin.org.

Depending upon how the various Bitcoin nodes are intended to be used, the nodes may execute different variations of the Bitcoin software providing additional Bitcoin capabilities, such as wallet and mining capabilities. Some of nodes A-E may be “full” nodes, i.e. may contain a full copy of the blockchain; other ones of nodes A-E may be Simplified Payment Verification (SPV) or “lightweight” clients that operate without a full copy of the blockchain.

As depicted schematically in FIG. 1, each of Bitcoin nodes A, B, C, D and E is situated in a distinct geographic location. In the illustrated example, nodes A and B are located in the United States; nodes C and D are located in England; and Node E is located in Somalia. Each of the nodes has a distinct IP address on the internet reflective of its geographic location. The IP address (which may be an IPv4 or IPv6 address for example) may have been automatically assigned using conventions specified by the Regional Internet Registry (RIR) and effected by the Domain Name System (DNS).

Bitcoin nodes A-E may be owned by one or more distinct parties, each desirous of participating in the Bitcoin cryptocurrency system. In this example, it is presumed that nodes A-D are being used for legitimate Bitcoin purposes, such as electronically purchasing goods or services with bitcoins. In contrast, Bitcoin node E is being used for illegitimate or illegal purposes, possibly including money laundering, purchasing illegal goods or services, supporting illegal organizations or terrorism, or avoiding financial sanctions.

As will be appreciated by those familiar with cryptocurrencies such as Bitcoin, illegitimate or illegal cryptocurrency transactions can be difficult to detect using conventional means, for various reasons. Fundamentally, access to the Bitcoin network is open to anyone from virtually any location in the world and is not mediated by a central authority such as a bank. A cryptocurrency transaction may be made without divulging any personal information as is required for initiating a financial transaction through a bank for example. Moreover, the computing power that would be required for a law enforcement agency to independently analyze Bitcoin transactions may be significant. At the time of this writing, the progressively growing Bitcoin blockchain has become so large that analyzing it in the context of an investigation may be difficult or impossible using legacy computer systems. The system and techniques described herein may address these difficulties, at least in part, by allowing an approximate geographic origin of a Bitcoin transaction to be determined, as will be described.

FIG. 1 adopts a convention whereby a solid line between Bitcoin nodes represents a Bitcoin P2P connection between those nodes; this convention is used throughout the drawings. For example, in FIG. 1, nodes A and B are peers whereas nodes A and C are not. All the illustrated Bitcoin nodes of FIG. 1 (except node Z, described below) are directly or indirectly connected to one another and collectively comprise the Bitcoin P2P mesh network.

As can be seen in FIG. 1, some Bitcoin nodes (e.g. nodes A, C, D and E) are depicted with emanating connections (lines) that are unconnected to any other node. These lines notionally represent connections to the rest of the Bitcoin network (not expressly shown), which may comprise many more cryptocurrency nodes.

To facilitate monitoring of Bitcoin transactions dynamically as they propagate through the Bitcoin network, an administrator may initially install a first listener node Z in a selected geographic area (the U.S. in this example—see FIG. 1). As used herein, the term “listener node” refers to an internet-connected computing device with the same baseline functionality as a conventional cryptocurrency node (e.g. a Bitcoin node having the functionality discussed above), but further customized for monitoring propagation of new Bitcoin transactions through the Bitcoin network and periodically reporting collected data to a central server, as will be described.

FIG. 1A is a schematic diagram depicting an example listener node 100, such as Node Z of FIG. 1. Other listener nodes may have a similar structure.

As illustrated in FIG. 1A, the example listener node 100 is a computing device 101, such as a server, a laptop computer, a tablet computer, or a smartphone, comprising a processor 102 and memory 104. The memory 104, which may for example be volatile memory, secondary storage, or a combination, stores Bitcoin daemon software (described above) for causing the computing device 101 to act as a Bitcoin node.

In the present embodiment, memory 104 also stores a full copy of the blockchain 108. This allows the listener node 100 to autonomously and authoritatively verify any Bitcoin transaction without external reference, serving blocks and transactions as peers may ask for them. However, alternative embodiments of listener nodes may be lightweight Bitcoin nodes that do not store the full blockchain.

The listener node 100 also has a system clock 112 that keeps the current date and time at the node 100, e.g. based on oscillations from a local hardware oscillator. The system clock 112 may for example be a utility of the operative operating system at computing device 101. Because some system clocks are susceptible to drift (e.g. ones based on lower precision quartz oscillators), the memory 104 may also store system clock synchronization client software 110. Periodic execution of this client software 110 may cause the system clock to become synchronized with an external reference clock of higher accuracy. As will be appreciated, periodic clock synchronization may help to ensure that measurements at each listener node are being made against substantially the same universal scale. This may permit timestamps associated with events (e.g. receipt of Bitcoin transactions) occurring at different ones of the geographically distributed listener nodes to be sequenced relative to one another with confidence.

The precision of clock synchronization that is needed between listener nodes in any given embodiment may depend on various factors, such as the speed at which cryptocurrency transactions are broadcast by the operative cryptocurrency technology. In one example embodiment using Bitcoin, the system clocks at different listener nodes are synchronized to within 1 millisecond of one another or better. Depending upon the required degree of synchronization precision, different clock-synching technologies may be suitable for synchronization purposes, such as the Network Time Protocol (NTP) daemon, which is described at doc.ntp.org, or Chrony, which is described at chrony.tuxfamily.org.

It will be appreciated that the example listener node 100 may have other components, such as network interface controllers for communicating with other Bitcoin nodes via a network 120, and others, that have been omitted from FIG. 1A for the sake of brevity.

In one example embodiment of listener node 100, the processor 102 may comprise 8 CPU cores, and the memory 104 may comprise 32 GB of RAM and 2 TB of secondary storage. The multiple CPU cores may facilitate timely execution of Bitcoin software, which is multithreaded. This may advantageously provide sufficient CPU cores to quickly react to new transactions as they arise. Moreover, having sufficient RAM may prevent software delay that could otherwise result from excessive memory swap operations.

It will be appreciated that the recommended specifications for a node (e.g. number of CPU cores, amount of primary and secondary storage, etc.) may change over time as the processing demands associated with the operative cryptocurrency (e.g. Bitcoin) increase. One reason for increasing processing demands may be the progressive increase in the size of the blockchain—presently about 105 GB in size and growing with each new transaction that is made—with the passage of time. One recent prediction suggests that the blockchain for Bitcoin will approximately double in size annually. As such, processing demands may also increase in the future if block sizes are increased 8- to 32-fold, as presently proposed for Bitcoin.

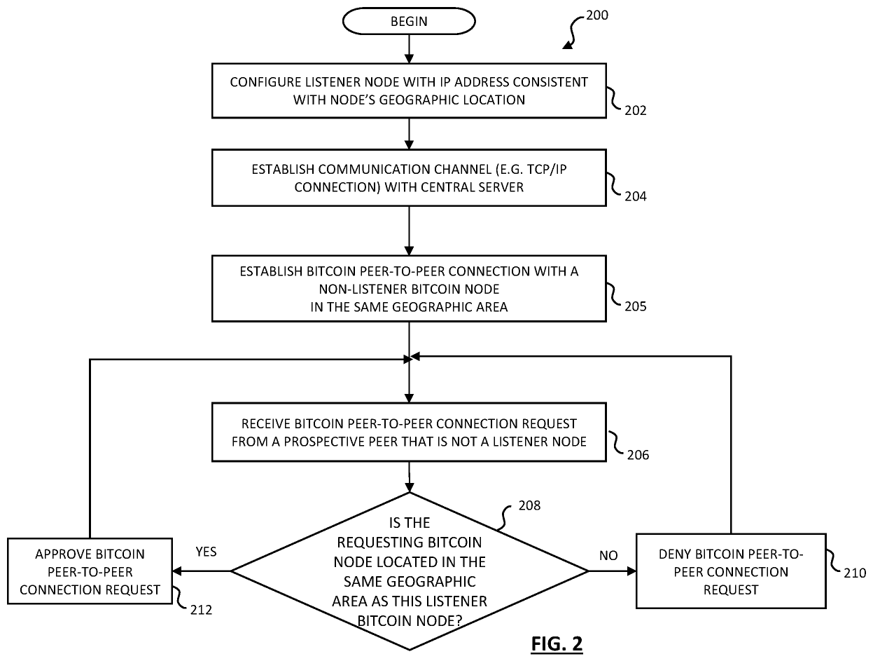

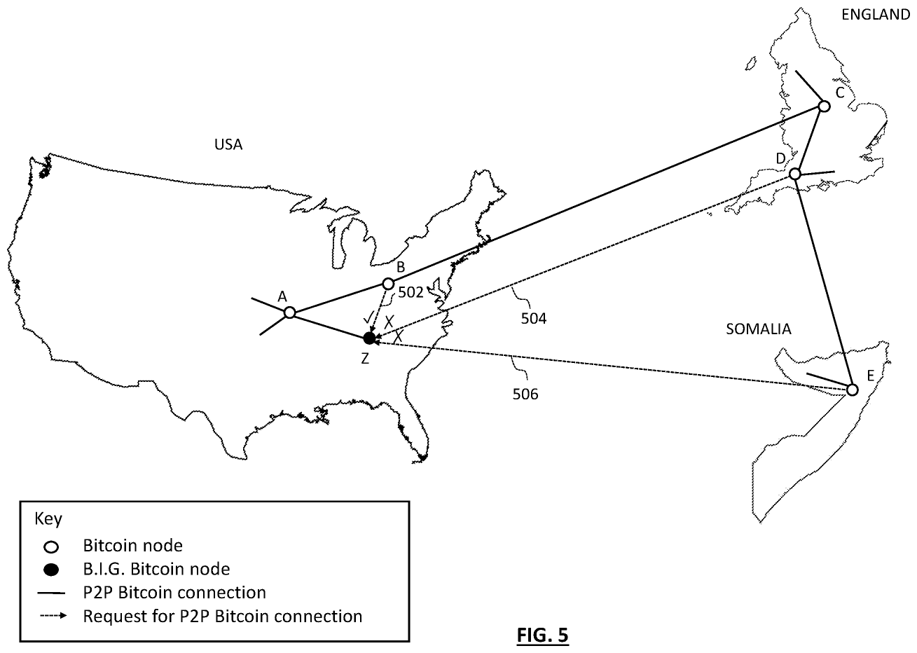

Referring again to FIG. 1, it should be noted that listener node Z has not yet been connected with the Bitcoin network. Connection is illustrated in FIGS. 2-4. FIGS. 5-7 show subsequent stages of progressive network growth.

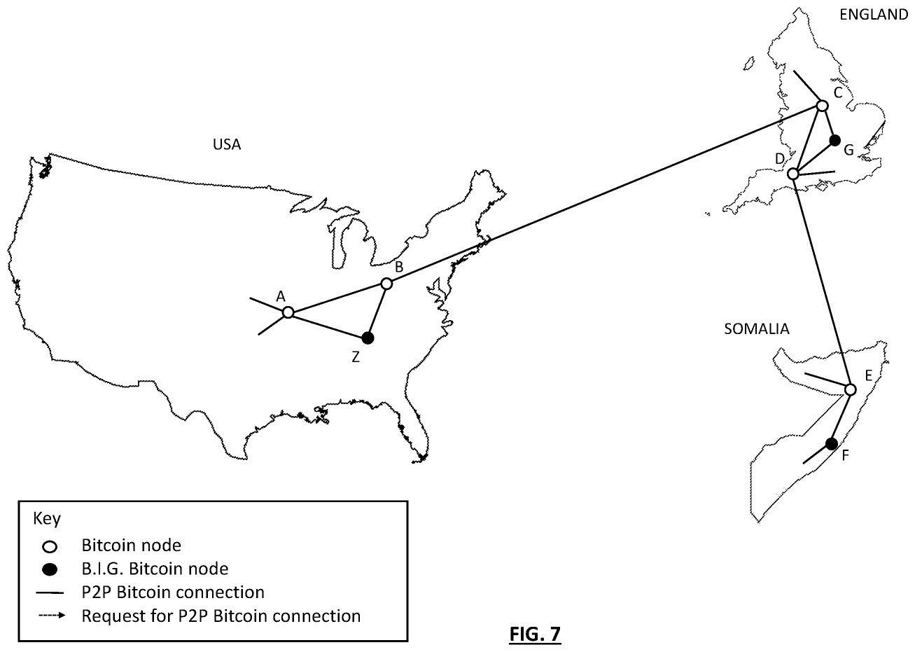

FIG. 2 depicts operation 200 of a single listener node 100 for connecting with the Bitcoin network and for maintaining the connection. It will be appreciated that the operation 200 depicted in FIG. 2 is performed not only by node Z, as described below, but by each listener node 100 forming part of the Bitcoin network (i.e. also nodes G and F of FIG. 7, described below).

Referring to FIG. 2, in operation 202, the listener node 100 is configured with an IP address consistent with the node's geographic location. In this example, it is presumed that listener node Z is configured with a U.S. IP address, consistent with American Registry for Internet Numbers (ARIN) rules, in operation 202. The IP address may have been assigned by an Internet Service Provider (ISP) or data center where the listener node is hosted.

In operation 204, the listener node 100 establishes a communication channel with the central server. The connection may for example be a TCP/IP connection via the internet. For clarity, the connection need not be a conventional P2P connection as between conventional cryptocurrency nodes.

In operation 205, the listener node 100 establishes a Bitcoin P2P connection (i.e. “peers”) with a Bitcoin node that: (a) is not itself a listener node; and (b) is in the same geographic area (e.g. same country) as the listener node. Operation 205 may be considered to “introduce” the listener node to the cryptocurrency network, as a preliminary step for the subsequent establishment of additional peer connections with other cryptocurrency nodes by operation of the Bitcoin protocol and as described below.

A rationale for the listener nodes “peering” (establishing a P2P connection in the cryptocurrency network) with only non-listener nodes is that, at least in the present embodiment, listener nodes do not themselves originate cryptocurrency transactions but only detect and relay such transactions. As such, it would be wasteful of resources to peer with another listener node, since any transactions coming from that node will not have originated there and, in any case, would have presumably already been detected and logged there.

Listener nodes peering exclusively with non-listener nodes may also help to maximize listener node penetration into the cryptocurrency network, i.e. may result in peering with as many possible originators of cryptocurrency transactions. Maximizing this penetration may help to maximize the effectiveness of the listener nodes for quickly detecting newly arising Bitcoin transactions. Speed of detection is important because, as a general rule, the more quickly a new transaction is detected relative to its time of creation, the more likely the detection will have occurred proximately to the transaction's geographic point of origin on the Bitcoin network. If detection were too slow, the new transaction may have already been spread over a larger geographic area by operation of the gossip protocol. By peering with, i.e. by being only one “hop” away from, as many cryptocurrency nodes that may originate Bitcoin transactions as possible, the listener node will position itself to detect any new transactions from any of those peers quickly.

Various mechanisms can be used at a listener node to avoid peering with other listener nodes. In one example, each listener node may maintain a list of IP addresses of all the other listener nodes and may avoid peering with any node whose IP address appears in the list. The listener node may achieve this result using conventional Bitcoin software functionality that prevents the node from peering with a specified set of nodes. The list of listener nodes may be obtained from the central server, which may maintain the list, or via an external software service.

A rationale for the listener node peering only with nodes in the same geographic area (e.g. country) is to facilitate identification of the geographic area in which a transaction has originated. For instance, presume that a listener node located in, say, France, is peered only with other Bitcoin nodes in France. If that listener node is the first to detect a Bitcoin transaction, then it can be concluded that the Bitcoin transaction likely originated in France (subject to certain caveats, addressed below).

The mechanism for establishing a peer connection with the non-listener node may be similar to the network discovery mechanism that is used by conventional Bitcoin nodes to connect with the Bitcoin network. For example, listener node Z may query the Domain Name System (DNS) using a number of “DNS seeds,” i.e. DNS servers that provide a list of IP addresses of Bitcoin nodes, to find a Bitcoin node whose IP address indicates co-location in the U.S. The Bitcoin software may also provide a list of Bitcoin nodes so that a newly established listener node can find additional peers. Once a connection is made to at least one peer, others can be discovered.

To facilitate peering only with cryptocurrency nodes in the same geographical area, a listener node may examine the IP address of each prospective peer. Each IP address may be correlated to a country using publicly or commercially available information, e.g. as provided by regional IP registrars. This information may be used to identify nodes in the same geographic area as the listener node.

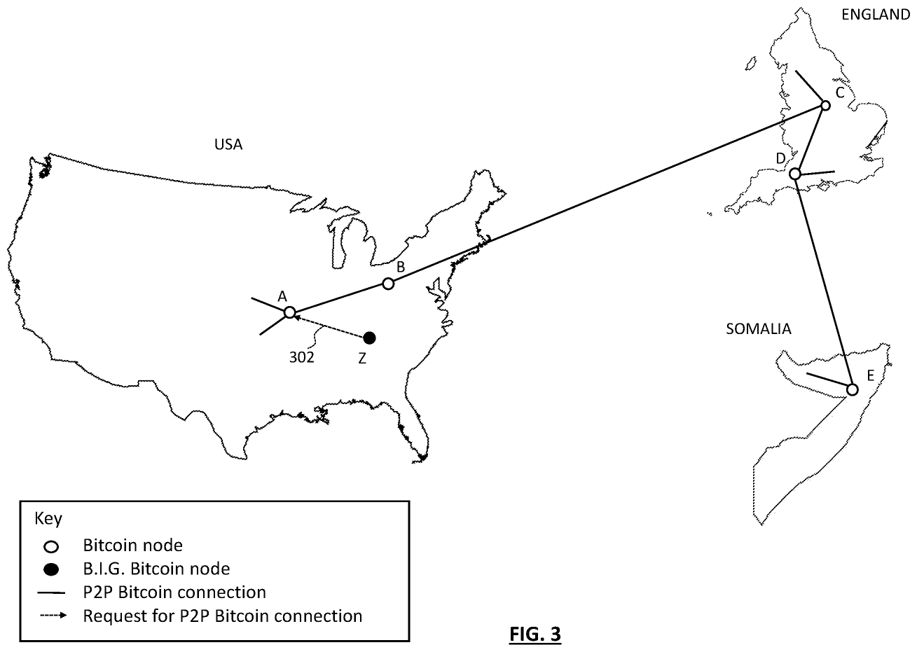

In the present example, it is presumed that listener node Z initially peers with Bitcoin node A (FIG. 1), which is also located in the United States. To establish the peer connection with node A, listener node Z may initially send Node A a request for a P2P Bitcoin connection, e.g. in the form of a version message that establishes the version of the Bitcoin software and the height of the blockchain at the relevant node. This request is represented as a dashed arrow 302 from the requesting node to the requested node in FIG. 3; the same convention will be carried forward in other drawings.

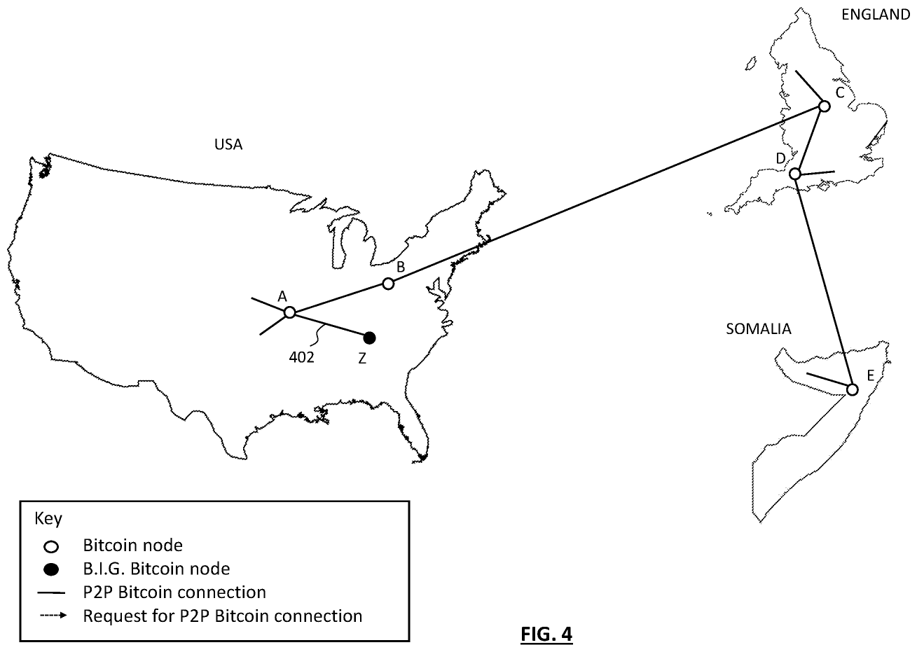

For illustration, it is presumed that Bitcoin node A grants the request from node Z. This may be done in the same manner as a conventional Bitcoin node's response to a peer connection request, e.g. with a verack message. In the result, a Bitcoin P2P connection is established between Nodes A and Z. The new peer relationship is represented as a solid line between the nodes in the schematic diagram of FIG. 4.

Subsequently, in operations 206-212 of FIG. 2, the listener node 100 forms P2P connections only with Bitcoin nodes that are in the same geographic area as itself—a process that may be referred to as “geo-fencing”—as demonstrated by the following example using listener node Z.

Initially, listener node Z receives a Bitcoin P2P connection request from a prospective peer that is not a listener node, namely Bitcoin node B of FIG. 5 (operation 206, FIG. 2). The request may arise during the normal course of operation of Bitcoin node B, as a standard function of Bitcoin's gossip protocol, and is represented as a dashed arrow 502 in FIG. 5. The listener node Z checks whether the prospective peer is in the same geographic area as itself (operation 208, FIG. 2). Node Z may for example do this by comparing the IP address of the requesting node with its own IP address, possibly in conjunction with a IP Country database that maps IP addresses to geographic regions (e.g. one of the GeopIP2™ and GeoLite2™ Country databases). The IP address of the requesting node may be known, e.g., from the addrMe field of a version message comprising the connection request, which may permit the listener node to ascertain the geographic location of prospective peer B.

The accuracy of IP address to geographic location mappings may vary between embodiments or between jurisdictions, e.g. dependent upon the accuracy of relevant mapping records that can be obtained from sources such as regional authorities. For example, if mapping records are obtained from a Regional Internet Registry, they may indicate that a parent IP address block is associated with an organization having headquarters in a particular city. However, if the organization is a large company or an ISP, the actual geographic location of devices using some of those IP addresses may distant from (e.g. on the other side of the country, in a different state/province from) the company headquarters. Some private “geoIP” companies may refine IP address mappings by allowing companies themselves to set geographic correlation to blocks of IP addresses, or by measurement. Regardless, in most cases mapping data can be relied upon with sufficiently high confidence to provide meaningful results.

In the present example, operation 208 reveals that nodes B and Z are indeed co-located in the same geographic area, i.e. the United States. Therefore, in a subsequent operation 212 (FIG. 2), the request for a Bitcoin P2P connection is approved, e.g. in the form of a verack message sent from node Z to node B. The approval of the P2P connection request is depicted in FIG. 5 as a check mark next to the dashed arrow representing the request. listener node Z subsequently awaits possible receipt of another Bitcoin P2P connection request (in the flowchart of FIG. 2, loop back to a point after operation 205).

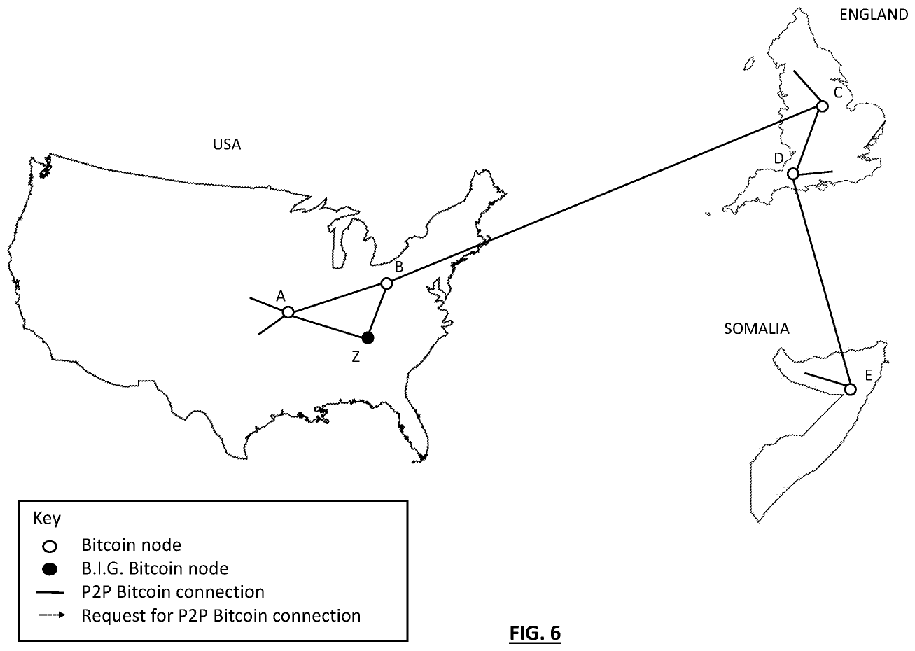

Subsequently, listener node Z receives another Bitcoin P2P connection request from a non-listener node, this time from Bitcoin node D (operation 206, FIG. 2). However, in this case the check performed in operation 208 reveals that the node D is not located in the same geographic area as listener node Z (the former being in England, the latter in the U.S.). Therefore, the Bitcoin P2P connection request is denied (operation 210, FIG. 2). The denial of the P2P connection request is depicted in FIG. 5 as an X next to the dashed arrow 504 representing the request. The denial may be effected as a lack of response to the request from the prospective peer. The same series of steps occurs in respect of the request 506 from Bitcoin node E, which is located in Somalia (see FIG. 5) and is therefore also denied for not being in the same geographic area as listener node Z. After these operations, the Bitcoin network will appear as it is depicted in FIG. 6.

It is presumed that, later, the administrator arranges for the instantiation of two new listener nodes G and F in England and Somalia, respectively. The new listener nodes may be installed in a locality (e.g. city) based on such factors as: whether the installation promotes substantially uniform coverage within a larger geographic area (e.g. one node in each major city of a country); whether the number of listener nodes in the locality is proportional to a “busyness” of the Bitcoin network in that locality; whether there is a particular interest in the locality, e.g. because it is a suspected origin of Bitcoin transactions of interest (such as fraudulent transactions); or practical considerations, such as considerations of network topology, available data center spec and/or available hardware.

Thereafter, the administrator may execute operation 200 of FIG. 2 at each of these nodes, ultimately resulting in the Bitcoin network portion depicted schematically in FIG. 7. Operations 208 and 210 of FIG. 2 ensure that, in the resultant network, no P2P Bitcoin connection from (with) a listener node will cross the border of any country (or, in implementations where the geo-fencing is performed for geographic areas other than countries, such as provinces, states, or counties for example, the border of the relevant geographic area).

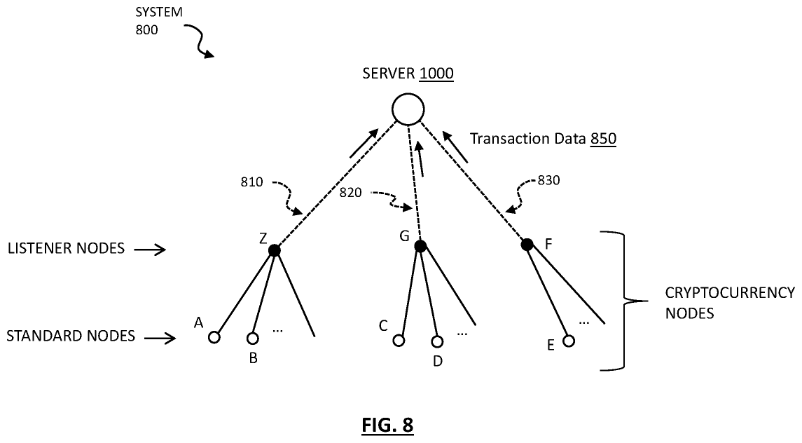

FIG. 8 is a schematic depiction of the system 800 resulting from the execution of operation 200 as described above. In FIG. 8, system 800 is represented as a tree having a root node, branches and leaves. The root node represents the central server 1000 (described below); the branches (one level below the root node) represent listener nodes Z, G and F; and the leaves represent cryptocurrency nodes that have peered with a listener node. Communication channels 810, 820 and 830, depicted in FIG. 8 using dashed lines, provide for communication of transaction data 850 (depicted using arrows in FIG. 8) from listener nodes Z, G and F respectively to server 1000. For clarity, the leaf nodes in FIG. 8 are referred to as “standard nodes” because they are conventional cryptocurrency nodes (e.g. standard Bitcoin nodes) rather than customized listener cryptocurrency nodes.

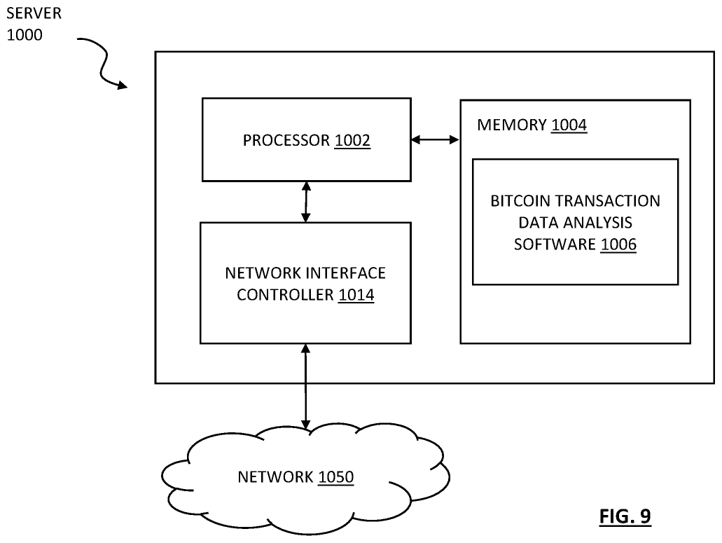

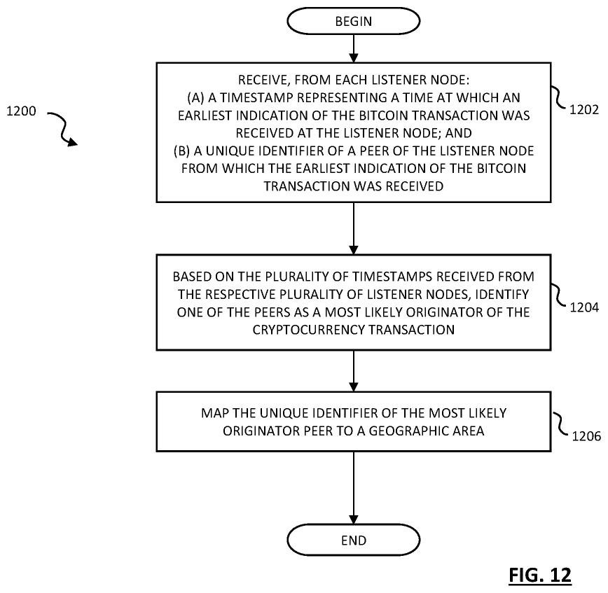

FIG. 9 schematically depicts, in greater detail, the central server 1000 that acts as the root node of FIG. 8. The server 1000 comprises a processor 1002 in communication with memory 1004, which may be volatile memory, secondary storage, or both. The processor 1002 may be a multiprocessor. The memory stores Bitcoin transaction data analysis software 1006, which is executable by the processor for causing the server 1000 to operate as illustrated in FIG. 12, described below, and as elsewhere described herein. A network interface controller 1014 in communication with the processor 1000 permits the server to establish connections with multiple listener nodes over a network 1050, which may be a wide area network such as the internet. The server 1000 may include other components that are omitted from FIG. 9 for brevity. The server 1000 may for example be hosted at a convenient geographic location, e.g. at an office of the administrator.

Referring again to FIG. 2, it will be appreciated that continued execution of operations 206, 208, 210 and 212 at each of listener nodes G, F and Z allows those nodes to dynamically adapt to the possibly changing topography of the Bitcoin network. The changing topography may result from, e.g., the removal and addition of Bitcoin nodes over time, as Bitcoin nodes are activated and deactivated in the normal course of their use. Operations 206, 208, 210 and 212 allow the listener nodes to dynamically reform their connections to remain connected to the Bitcoin network even if one or more of their peers is removed from the Bitcoin network. The listener nodes thus become part of the Bitcoin network and automatically maintain themselves as such. The continued connectivity of Bitcoin nodes may be facilitated by the Bitcoin gossip P2P network defined in the Bitcoin protocol.

In the system depicted in FIGS. 7 and 8, the listener nodes are geographically distributed relative to one another. One possible way of implementing this geographic distribution may be to instantiate listener nodes using hardware sourced from established data centers in locations in different countries. In this document, the term “data center” refers to a business that rents space for internet-connected computing equipment, and possibly the computing equipment itself, to its clients. In some embodiments, a single physical server may host eight or more listener nodes. Several such physical servers may be hosted at a single data center and may share network resources. In this way, it may be possible to provide many listener nodes at each data center, which in turn may permit a high peer ratio to be achieved (e.g. >90% of Bitcoin nodes peered with a listener node).

In some embodiments, the recommended minimum number of listener nodes may be equal to the total number of Bitcoin nodes (other than listener nodes) divided by 64. At the time of this writing, the total number of Bitcoin nodes is approximately 7000, thus, in such embodiments, a minimum of about 110 listener nodes may be advisable. If the network is partitioned (split into multiple parts) at some point in the future, this recommended number may change. In general, it is desirable for the number of listener nodes to be sufficient for peering with as many non-listener nodes as possible for operation as described herein, with a higher number of “covered peers” (i.e. non-listener nodes peered with listener nodes) tending to yield higher accuracy approximations of the geographic origin of newly arising cryptocurrency transactions.

The geographic distribution of the listener nodes may be based on several factors. A first factor may be a desire to provide at least one listener node in each geographic region (e.g. country) in the world. A second factor may be a desire for the number of Bitcoin nodes in each geographic region to be generally proportional to a number of Bitcoin transactions occurring in that region. For example, countries where Bitcoin is popular, such as the USA or Germany, may have more Bitcoin nodes than countries where only a few transactions take place. A third factor may be a desire for the number of Bitcoin nodes in each geographic region to be generally proportional to the expected number of illegal or fraudulent Bitcoin transactions originating in that region. These factors may be implementation-specific.

### (b) Using the Geographically Distributed Listener Nodes to Approximate a Geographic Origin of a Cryptocurrency Transaction

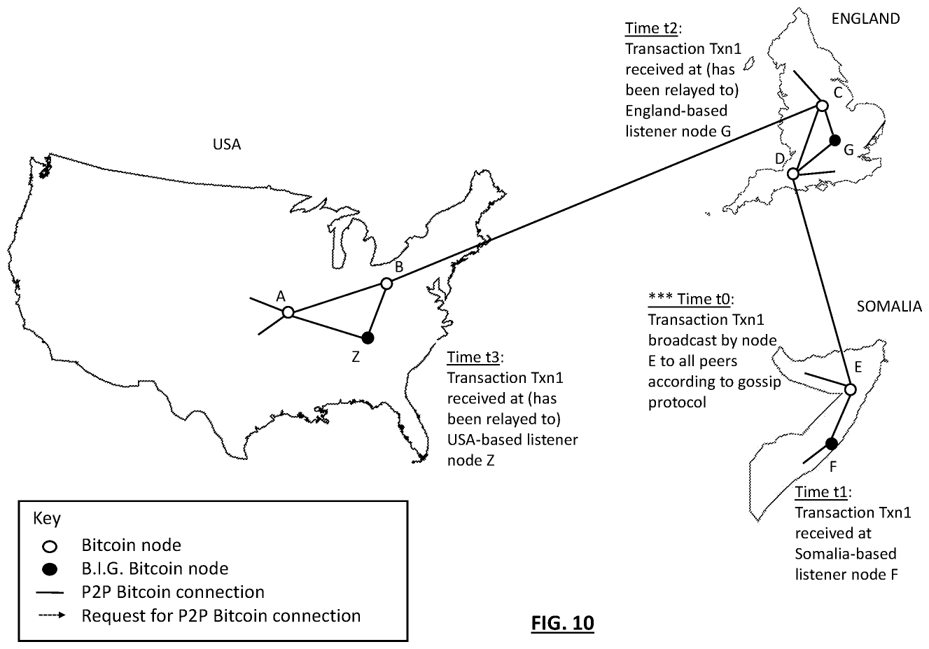

FIG. 10 schematically depicts use of the network of listener nodes of FIG. 7 for monitoring the propagation of an example Bitcoin transaction through the Bitcoin network.

At a first time t0, a Bitcoin transaction Txn1 is originated at Somalia-based Bitcoin node E. In this example, the Bitcoin transaction Txn1 is presumed to have originated from a Bitcoin address Addr1 associated with a particular Bitcoin wallet W1 hosted at node E (neither the address nor the wallet being expressly depicted in FIG. 8). The example transaction Txn1 may for example represent a payment of an amount equal to $100,000 U.S. dollars from Bitcoin address Addr1 to another Bitcoin address Addr2 associated with a different Bitcoin wallet W2 hosted at another Bitcoin node X (none being depicted in FIG. 10). In this example, transaction Txn1 represents an illegal payment, e.g. having been made in violation of the criminal code of the country of origination and/or of the destination country, such as a payment for illegal goods or services or payment to a Bitcoin address that is known to belong to an illegal or sanctioned organization.

As is known to those familiar with Bitcoin cryptocurrency, the transaction is transmitted as a data structure, which may comprise the fields shown in Table 1 below, in accordance with the Bitcoin protocol:

TABLE 1
Transaction Data Structure

| Field | Description |
|---|---|
| Version | Identifier of rule set that this transaction follows |
| Input counter | Number of transaction input(s) |
| Input | Transaction input(s) |
| Output counter | Number of transaction output(s) |
| Output | Transaction output(s) |
| Locktime | Earliest time transaction is valid/propagatable |

The Input field is itself a data structure comprising information about the bitcoins to be transferred via transaction Tx1, possibly being structured as shown in Table 2 below:

TABLE 2
Transaction Input Data Structure

| Field | Description |
|---|---|
| Transaction | A unique identifier of a transaction in the blockchain |
| Hash | containing unspent transaction output (UTXO), i.e. |
| | spendable bitcoin of the “payer” in this |
| | transaction |
| Output Index | Index number of UTXO to be spent |
| Unlocking | Unlocking script length in bytes |
| Script Size | |
| Unlocking | A script fulfilling the conditions of the UTXO locking |
| Script | script (typically a digital signature proving ownership |
| | of the Bitcoin address of the “payer” in this |
| | transaction) |
| Sequence | (unused at present) |
| Number | |

The Output field of the transaction Txn1 is also a data structure as shown in Table 3 below:

TABLE 3
Transaction Output Data Structure

| Field | Description |
|---|---|
| Amount | Bitcoin value to be transferred, in Satoshis |
| | (10-8 bitcoins) |
| Locking Script | Locking script length in bytes |
| Size | |
| Locking Script | A script defining the conditions needed to spend the |
| | transferred amount, typically requiring the digital |
| | signature of the Bitcoin address of the “payee” |
| | in this transaction |

In practice, the data structure representing transaction Txn1 may be approximately 300 to 400+ bytes long.

In accordance with conventional Bitcoin node functionality, at time t0, Somalia-based Bitcoin node E broadcasts the new Bitcoin transaction Txn1, via the INV message, to all of its peers, so that they can validate the transaction and relay it to their peers, and so on, to flood all nodes in the Bitcoin network with the transaction in a short period of time, using the gossip protocol. Each transmitted copy of the transaction may be considered as a distinct indication of Bitcoin transaction Txn1. Typically, appropriate checks are performed before the transaction is broadcast to ensure that the transaction is valid, in accordance with the Bitcoin protocol. Once the broadcasting node sends the transaction hash (unique transaction identifier) to all its peers, any peers not having that transaction in their inventory already will respond with a request for the content of the transaction. In the present example, peers of originating node E include listener node F co-located in Somalia.

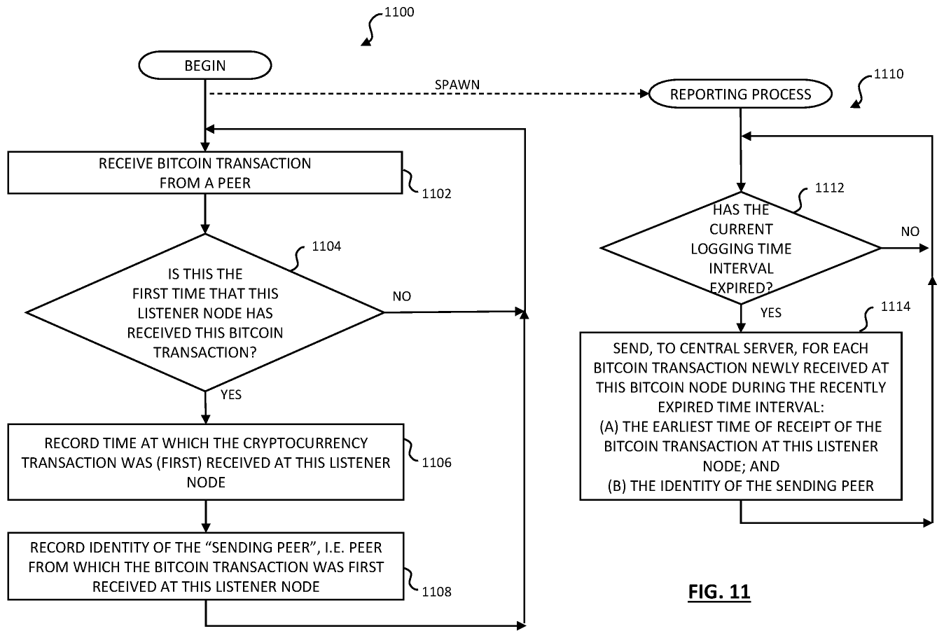

Receipt of a transaction at a listener node triggers operation 1100 of FIG. 11. Referring to FIG. 11 in conjunction with FIG. 10, in the present example, the listener node F is the first to receive Bitcoin transaction Txn1 from Bitcoin node E, at time t1 (operation 1102, FIG. 11).

Subsequently, listener node F (FIG. 10) checks whether this is the first time that it has received transaction Txn1 (operation 1104, FIG. 11). In the present example, the check reveals that node F has indeed received transaction Txn1 for the first time. As a result, the time t1 at which Bitcoin transaction Txn1 was received at node F is recorded (operation 1106, FIG. 11), i.e. a timestamp is generated. The timestamp may represent the time at which the INV message informing the listener node of that Bitcoin transaction was received. The timestamp may be logged in conjunction with a unique identifier of the relevant Bitcoin transaction (e.g. the Bitcoin transaction hash) and the identity of the sending peer, i.e. the peer from which the Bitcoin transaction was first received at the present listener node. The recorded identity may be a unique identifier of the sending peer, such as its IP address.

By virtue of the gossip protocol that is used in Bitcoin (and other cryptocurrency) networks, a Bitcoin node (whether it is a listener node or otherwise) may receive multiple copies (indications) of the same cryptocurrency transaction from respective peers as the transaction floods the network. If a listener node receives a redundant indication of a transaction (operation 1102, FIG. 11), the check performed in operation 1104 will be evaluated in the negative, and the logging operations 1106 and 1108 will not be performed. This ensures that only the earliest time of receipt and associated sending peer of each unique transaction is logged at each listener node.

Referring again to FIG. 11, a reporting process 1110 (FIG. 11) is also spawned at the listener node. This process periodically sends a report of the earliest times of receipt of each new cryptocurrency transaction received during the recently expired logging time interval. In particular, upon expiry of the time interval (operation 1112, FIG. 11), which may be on the order of several seconds in some embodiments, the node sends, to central server 1000, for each Bitcoin transaction received for the first time at that node during that interval, (a) the earliest time of receipt of the Bitcoin transaction at this listener node; and (b) the identity (e.g. IP address) of the sending peer (operation 1114, FIG. 11). This transaction data 850 (FIG. 8) may be communicated to the server 1000 in various ways, e.g. as electronic messages, an electronic file, or by making database entries into a database on the central server. Once this information has been sent, a new time interval may be considered to commence (operation 1112, FIG. 11), and the logging may begin anew for transactions received during the new interval.

Due to the execution of operation 1100 at each of listener nodes F, G and Z, the central server 1000 will periodically receive reports the above-described reports from each of these nodes. In the present example, it is presumed that these reports include indications of the first times of receipt t1, t2, and t3, respectively, of Bitcoin transaction Txn1 at listener nodes F, G, and Z respectively. By virtue of the time-synching of the listener nodes (described above), all of the times t1, t2, and t3 will have been measured according to a universally synchronized time scale, within an acceptable tolerance (e.g. 1 msec). In the present example, it is assumed that time t1 is earlier than time t2 and time t2 is earlier than time t3. In other words, the timestamps indicate that listener nodes F, G and Z, located in Somalia, England, and the USA respectively, were apprised of Bitcoin transaction Txn1 in that order.

FIG. 12 depicts, in flowchart form, operation 1200 of the central server 1000, executing software 1006 (FIG. 9), for approximating a geographic origin of a particular transaction, based on the reports sent by the various listener nodes in operation 1114 of FIG. 11. The triggering event for operation 1200 may for example be a query regarding a specific transaction, which in this example is transaction Txn1. The query may for example be automatically initiated by a software process or manually initiated by a user interacting with software 1006 at the server 1000 (FIG. 9). In some embodiments, operation 1200 (FIG. 12) may be performed automatically for each Bitcoin transaction, with the results being stored in a database for possible future use.

In operation 1202 (FIG. 12), the server 1000 receives, from each listener node Z, G, and F in our example: (a) a timestamp representing a time at which an earliest indication of the Bitcoin transaction Txn1 was received at the listener node; and (b) a unique identifier of the sending peer of the listener node from which the earliest indication of the Bitcoin transaction Txn1 was received. The receiving of transaction data 850 (FIG. 8) from the different listener nodes in operation 1202 may occur piecemeal. In one embodiment, data 850 is sent in the form of triplets comprising a timestamp, an IP address, and a Bitcoin transaction hash. A representation of the received transaction data 850 for transaction Txn1 is shown in Table 4 below.

TABLE 4
Transaction data for transaction Txn1

| Time of | Received at | | Location of |
|---|---|---|---|
| Receipt | Listener Node | Sending Peer | Sending Peer |
| t1 | F | E | Somalia* |
| t2 (t1 + 1 sec) | G | D | England |
| t3 (t1 + 2 sec) | Z | B | USA |

In operation 1204 (FIG. 12), based on the plurality of timestamps received from the respective plurality of listener nodes F, G and Z, the server 1000 identifies one of the peers as a most likely originator of the Bitcoin transaction Txn1. This may be done by identifying the earliest timestamp received in operation 1202 and then identifying the sending peer from which the transaction Txn1 was received at the time represented by that timestamp. Referring to Table 4, it can be seen that the earliest timestamp t1 was received from Bitcoin node E (first table row). As such, the sending peer E is identified as a most likely originator of transaction Txn1 in this example.

Finally, in operation 1206 (FIG. 12), server 1000 maps the unique identifier of the most likely originator peer (Bitcoin node E) to a geographic area. In this example, the unique IP address of Bitcoin node E is mapped to the country of Somalia, e.g. using a commercially or publicly available IP address to geographic location mapping. As such, operation 1200 approximates the geographic origin of Bitcoin transaction Txn1 to the country of Somalia (as denoted in Table 4 by the asterisk following the word “Somalia”). The geographic origin may be considered as an approximation due to possible limitations in the accuracy or granularity of the mapping data, as described above, or because the peer that is identified as in operation 1204 is not actually the true originator node of transaction Txn1. The latter situation may arise, for example, if no listener node has established a P2P connection with the Bitcoin node that actually originated transaction Txn1. Another reason that the geographic origin may be considered approximate is that the geographic location resulting from the mapping may encompass a physical area that is sizeable (e.g. a country or a portion thereof).

It will be appreciated that the accuracy of the approximation of geographic origin made using the foregoing techniques may vary between transactions. For example, if a Bitcoin transaction originates from a node operated on the dark web or TOR network, then the geographic origin of the transaction may be approximated at or near the exit point of that transaction from the TOR network onto the internet rather than at or near the actual geographic location of the originating node. Obtaining data regarding known dark web or TOR exit points may help to identify transactions possibly originating from the dark web or TOR. In any case, because operating a full Bitcoin node is becoming increasingly resource intensive, it is generally more common for users to subscribe to a web wallet or service such as Electrum™ or others to transact Bitcoin. It is unlikely that legitimate operators of web wallets would use the TOR network, thus it is expected that the vast majority of cryptocurrency transactions would be geographically traceable using the above-described techniques.

Once a geographic origin for a particular transaction Txn1 has been approximated by the operations of FIG. 12, then that information can be used to automatically flag the transaction, or related transactions (e.g. transactions originating from the same Bitcoin address and/or the same Bitcoin wallet), in certain circumstances. One such circumstance may be if the geographic area is known to be associated with a high crime area or high risk of fraud.

In some embodiments, the Bitcoin transaction data analysis software 1006 may provide a convenient Application Programming Interface (API) for use by, e.g., law enforcement, governments, or Bitcoin users, executing their own software. For example, an API call may accept as a parameter a unique cryptocurrency transaction identifier (e.g. a Bitcoin hash) and may provide, as a result, an indication of the approximate geographic origin of a transaction of interest or a score indicative of a degree of risk, akin to a credit score, associated with the approximate geographic origin. The invoker of such an API call may use the result to flag suspect transactions as possibly fraudulent. Alternatively, a cryptocurrency user could possibly use the result of such an API call as a basis for rejecting a future transaction from an associated Bitcoin address or wallet. In this context, “rejecting” a transaction may mean checking a Bitcoin address a priori and not sending any money to it if a score exceeds a threshold. “Rejecting” a transaction may also mean, before accepting any money from a prospective payer, asking for the Bitcoin address that will be used to pay, using the API call to obtain a “degree of risk” score for that address, and decline to accept payment for a score that exceeds a threshold. The foregoing steps could be automated in some embodiments. “Rejecting” may also mean automatically flagging or suspending an account pending review at a hosted wallet provider.

It will be appreciated that the example in this description are simplified for the sake of brevity, e.g. depicting only three listener nodes. In practice, the number of listener nodes may be significantly higher than three.

Various alternative embodiments are possible.

In the above embodiment, peering of a listener node with another node was initiated by transmission of a version message. It will be appreciated that, in alternative embodiments, peering may be initiated in other ways, e.g. the INV message, as defined within the Bitcoin protocol.

In the foregoing examples, IP address is used to uniquely identify cryptocurrency nodes in the cryptocurrency network. It will be appreciated that, in alternative embodiments, other unique identifiers of cryptocurrency nodes could be used. Whatever form of unique identifier is used, there should be some mechanism for mapping the identifiers to geographic locations.

Although the examples illustrated in this document all employ the Bitcoin cryptocurrency, alternative embodiments could be implemented for cryptocurrencies other than Bitcoin that employ a network of P2P nodes using a well-defined protocol for exchanging information.

In some embodiments, a listener node may adjust or augment each recorded time of receipt of a cryptocurrency transaction from a sending peer to compensate for network latency between the listener node and the sending peer. The adjustment may be considered to more closely approximate ideal conditions in which communication of the cryptocurrency transaction from the sending peer to the listener node is instantaneous. As such, the adjusted time may be considered to represent not only the time of receipt of the transaction at the listener node, but also the time at which the sending peer is known to have been aware of the cryptocurrency transaction. The timestamp that is reported to the central server may reflect this adjustment.

To support this functionality, the listener nodes of such embodiments may periodically measure a latency or travel time, in the P2P mesh network, between the listener node and each sending peer. The latency or travel time between the sending peer and the receiving listener node can be measured in a variety of ways, including transmission of a “ping” message. The adjustment may improve the accuracy of the identification of the probable originating cryptocurrency node.

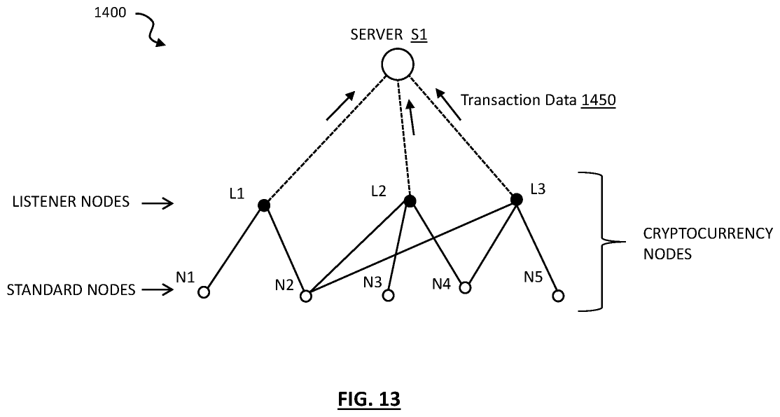

In the example system 800 described above, each listener node peers with a distinct set of cryptocurrency nodes that does not overlap with set of peers of any other listener node. In other words, no standard (non-listener) cryptocurrency node of system 800 is peered with more than one listener node. This is not necessarily true of all embodiments. In some embodiments, standard cryptocurrency nodes may be peered with multiple listener nodes. Such an alternative embodiment is depicted in FIG. 13.

Referring to FIG. 13, an alternative system 1400 is depicted using the same tree notation used in FIG. 8. The root node represents a central server Si with similar functionality to server 1000 described above. The branches (one level below the root node) represent three listener nodes L1, L2 and L3, with similar functionality to the listener nodes described above but allowing for shared peers between listener nodes. The leaves N1, N2, N3, N4, and N5 represent standard cryptocurrency nodes, each of which has peered with at least one listener node. Notably, node N4 has peered with two different listener nodes L2 and L3, and node N2 has peered with all three depicted listener nodes L1, L2 and L3.

It will be appreciated that, in the depicted system 1400, a cryptocurrency transaction originating from (broadcast by) either of standard nodes N2 or N4 will be detected by multiple listener nodes. This effectively corroborates the detection of cryptocurrency transactions from those cryptocurrency nodes and may permit the implementation of more sophisticated assessments of which cryptocurrency node has most likely originated the cryptocurrency transaction.

For example, in the system 1400 of FIG. 13, the server Si may perform a form of “post processing” of the transaction data 1450 received from the listener nodes L1, L2 and L3. The post processing may apply a weighting scheme for choosing, as a most likely originator node of a cryptocurrency transaction (per operation 1204 of FIG. 12), a sending peer that is not necessarily the one from which an indication of the cryptocurrency transaction was earliest received at a listener node. Rather, the weighting scheme may preferentially weight: (a) peers from which the cryptocurrency transaction were earlier received over peers from which the indication of the cryptocurrency transaction were later received; and (b) peers from which the cryptocurrency transaction was received a greater number of the N earliest times of receipt over peers from which the cryptocurrency transaction was received a fewer number of the N earliest times of receipt, where N is an integer greater than one.

For example, the weighting scheme may be as shown in Table 5 below (where N=5):

TABLE 5
Weighting scheme for identifying likely originator
node of a cryptocurrency transaction

| Timestamp (time of receipt of the | |
|---|---|
| transaction at any listener node) | Weight |
| Earliest | 30% |
| Second earliest | 25% |
| Third Earliest | 20% |
| Fourth Earliest | 15% |
| Fifth Earliest | 10% |

For illustration, presume server Si has compiled transaction data 1450, for a transaction of interest, as show in the first two columns of Table 6 below:

TABLE 6
Transaction data for a particular cryptocurrency transaction

| Timestamp | ID of Sending Peer | Weight |
|---|---|---|
| Earliest | N4 | 30% |
| Second earliest | N2 | 25% |
| Third Earliest | N2 | 20% |
| Fourth Earliest | N2 | 15% |
| Fifth Earliest | N4 | 10% |

When the weighting scheme of Table 5 (reproduced in column 3 of Table 6 for convenience) is applied to the data of the first two columns of Table 6, the result is as follows:

Probability for node N4=sum(weights)(N4)=30+10=40% [Equation 1]

Probability for node N2=sum(weights)(N2)=25+20+15=60% [Equation 2]

As will be apparent from Equations 1 and 2 above, the probability that node N2 is the originating node (60%) greater than the probability that node N4 is the originating node (40%). Therefore, in this example, cryptocurrency node N2 is deemed to be the most likely originator of the relevant cryptocurrency transaction, even though the earliest indication of that transaction was received from node N4 rather than node N2.

In some embodiments, the identities of each of the possible originating nodes (e.g. all nodes mentioned in Table 5) may be presented in a graphical user interface along with their associated computed probabilities of being the originator node.

In the embodiments described above, the example cryptocurrency is Bitcoin. It will be appreciated that the techniques described herein may be used for other forms of cryptocurrency, such Litecoin, Ethereum, Ethereum Classic, and Bitcoin Cash for example.

Other modifications may be made within the scope of the claims.

What is claimed is:

1. A server for approximating a geographic origin of a cryptocurrency transaction in a peer-to-peer (P2P) mesh network of cryptocurrency nodes employing a gossip protocol, the server comprising:
a network interface controller for communicating with a plurality of geographically distributed cryptocurrency nodes forming part of the P2P mesh network of cryptocurrency nodes; and
a processor, in communication with the network interface controller, operable to:
receive, from each cryptocurrency node of the plurality of geographically distributed cryptocurrency nodes:
a timestamp representing a time at which an earliest indication of the cryptocurrency transaction was received at the cryptocurrency node; and
a unique identifier of a peer of the cryptocurrency node, the peer forming part of the P2P mesh network of cryptocurrency nodes, from which the earliest indication of the cryptocurrency transaction was received;
based on the plurality of timestamps received from the respective plurality of geographically distributed cryptocurrency nodes, identify one of the peers as a most likely originator of the cryptocurrency transaction; and
map the unique identifier of the most likely originator peer to a geographic area.

2. The server of claim 1 wherein the unique identifier of the most likely originator peer is an Internet Protocol (IP) address of the peer.

3. The server of claim 2 wherein the mapping comprises determining that the IP address of the peer falls within a set of IP addresses known to have been allocated for use in the geographic area.

4. A cryptocurrency node for facilitating approximation of a geographic origin of a cryptocurrency transaction in a peer-to-peer (P2P) mesh network of cryptocurrency nodes, the cryptocurrency node comprising:
a system clock; and
a processor operable to cause the cryptocurrency node to:
receive, from at least one peer of the cryptocurrency node within the P2P mesh network of cryptocurrency nodes, at least one indication of the cryptocurrency transaction conveyed using a gossip protocol;
record a time, using the system clock, at which the first indication of the cryptocurrency transaction was received at the cryptocurrency node; and
record a unique identifier of the peer from which the first indication of the cryptocurrency transaction was received at the cryptocurrency node.

5. The cryptocurrency node of claim 4 wherein the processor is further operable to cause the cryptocurrency node to transmit, to a server:
the recorded time at which the first indication of the cryptocurrency transaction was received at the cryptocurrency node; and
the recorded unique identifier of the peer of the cryptocurrency node from which the first indication of the digital cryptocurrency transaction was received.

6. The cryptocurrency node of claim 5 wherein the processor is further operable to:
measure a latency, in the P2P mesh network, between the cryptocurrency node and the peer from which the first indication of the cryptocurrency transaction was received; and
prior to the transmitting of the recorded time to the server, adjust or augment the recorded time to compensate for the measured latency between the cryptocurrency node and the peer from which the first indication of the cryptocurrency transaction was received.

7. The cryptocurrency node of claim 4 wherein the processor is further operable to cause the cryptocurrency node to:
receive a peer connection request from a prospective peer;
ascertain, from the peer connection request, a geographic location of the prospective peer; and
accept the peer connection request only if the prospective peer is located within the same geographical area as the cryptocurrency node.

8. The cryptocurrency node of claim 7 wherein the geographical area is a country.

9. The cryptocurrency node of claim 4 wherein the processor is a multi-core processor.

10. The cryptocurrency node of claim 4 wherein the cryptocurrency is Bitcoin and wherein the cryptocurrency node comprises a computing device executing Bitcoin daemon software.

11. The cryptocurrency node of claim 4 wherein the system clock is periodically synchronized with an external reference clock.

12. A system for approximating a geographic origin of a cryptocurrency transaction in a peer-to-peer (P2P) mesh network of cryptocurrency nodes, the system comprising:
a plurality of geographically distributed cryptocurrency nodes forming part of the P2P mesh network, each of the cryptocurrency nodes of the plurality operable to:
receive, from at least one peer of the cryptocurrency node within the P2P mesh network, at least one indication of the cryptocurrency transaction conveyed using a gossip protocol;
record a time at which the first indication of the cryptocurrency transaction was received at the cryptocurrency node; and
record a unique identifier of the peer from which the first indication of the cryptocurrency transaction was received at the cryptocurrency node; and
a server, in communication with each of the geographically distributed cryptocurrency nodes, operable to:
receive, from each cryptocurrency node of the plurality of geographically distributed cryptocurrency nodes:
a timestamp representing the recorded time at which the earliest indication of the cryptocurrency transaction was received at the cryptocurrency node; and
a unique identifier of the peer of the cryptocurrency node from which the earliest indication of the cryptocurrency transaction was received;
based on the plurality of timestamps received from the respective plurality of geographically distributed cryptocurrency nodes, identify one of the peers as a most likely originator of the cryptocurrency transaction; and
map the unique identifier of the most likely originator peer to a geographic area.

13. The system of claim 12 wherein the identifying of one of the peers as the most likely originator of the cryptocurrency transaction comprises:
based on the timestamps, selecting the peer from which the indication of the cryptocurrency transaction was earliest received.

14. The system of claim 12 wherein at least some of the peers are peered with multiple ones of the geographically distributed cryptocurrency nodes.

15. The system of claim 14 wherein the identifying of one of the peers as the most likely originator of the cryptocurrency transaction comprises:
based on the timestamps, identifying the N earliest times of receipt of the indication of the cryptocurrency transaction at any of the geographically distributed cryptocurrency nodes, where N is an integer greater than one;
selecting the peers from which the indications of the cryptocurrency transaction were received at the identified N earliest times; and
choosing one of the selected peers based on a weighting scheme that preferentially weights:
peers from which the indication of the cryptocurrency transaction were earlier received over peers from which the indication of the cryptocurrency transaction were later received; and
peers from which the indication of the cryptocurrency transaction were received a greater number of the identified N earliest times over peers from which the indication of the cryptocurrency transaction were received a fewer number of the identified N earliest times.

16. The system of claim 12 wherein the geographically distributed cryptocurrency nodes have respective system clocks that are used to measure the respective recorded times and wherein the system clocks are periodically synchronized to a common reference clock.

17. The system of claim 12 wherein none of the peers are peered with multiple ones of the geographically distributed cryptocurrency nodes.

18. A method for approximating a geographic origin of a cryptocurrency transaction in a peer-to-peer (P2P) mesh network of cryptocurrency nodes, the method comprising:
at each cryptocurrency node of a plurality of geographically distributed cryptocurrency nodes forming part of the P2P mesh network:
receiving, from at least one peer of the cryptocurrency node within the P2P mesh network, at least one indication of the cryptocurrency transaction conveyed using a gossip protocol;
recording a time at which the first indication of the cryptocurrency transaction was received at the cryptocurrency node; and
recording a unique identifier of the peer from which the first indication of the cryptocurrency transaction was received at the cryptocurrency node; and
receiving, from each cryptocurrency node of the plurality of geographically distributed cryptocurrency nodes:
a timestamp representing the recorded time at which the earliest indication of the cryptocurrency transaction was received at the cryptocurrency node; and
a unique identifier of the peer of the cryptocurrency node from which the earliest indication of the cryptocurrency transaction was received;
based on the plurality of timestamps received from the respective plurality of geographically distributed cryptocurrency nodes, identifying one of the peers as a most likely originator of the cryptocurrency transaction; and
mapping the unique identifier of the most likely originator peer to a geographic area.

19. The method of claim 18 wherein the identifying of one of the peers as the most likely originator of the cryptocurrency transaction comprises, based on the timestamps, selecting the peer from which the indication of the cryptocurrency transaction was earliest received.

20. The method of claim 18 wherein at least some of the peers are peered with multiple ones of the geographically distributed cryptocurrency nodes and wherein the identifying of one of the peers as the most likely originator of the cryptocurrency transaction comprises:
based on the timestamps, identifying the N earliest times of receipt of the indication of the cryptocurrency transaction at any of the geographically distributed cryptocurrency nodes, where N is an integer greater than one;
selecting the peers from which the indications of the cryptocurrency transaction were received at the identified N earliest times; and
choosing one of the selected peers based on a weighting scheme that preferentially weights:
peers from which the indication of the cryptocurrency transaction were earlier received over peers from which the indication of the cryptocurrency transaction were later received; and
peers from which the indication of the cryptocurrency transaction were received a greater number of the identified N earliest times over peers from which the indication of the cryptocurrency transaction were received a fewer number of the identified N earliest times.
